(19) United States
(12) Patent Application Publication
(10) Pub. No.: US 2025/0362082 A1
(43) Pub. Date: Nov. 27, 2025

(54) HEAT RECOVERY SYSTEM FOR KILN AND METHOD FOR RECOVERING HEAT FROM SOLIDS PROCESSED IN A KILN

(71) Applicant: INNORD, INC., Boucherville (CA)

(72) Inventor: Pouya HAJIANI, Carignan (CA)

(21) Appl. No.: 18/872,515

(22) PCT Filed: Jun. 7, 2023
(86) PCT No.: PCT/CA2023/050777

§ 371 Date: Dec. 6, 2024

Related U.S. Application Data
(60) Provisional application No. 63/365,967, filed on Jun. 7, 2022.
(60) Provisional application No. 63/367,159, filed on Jun. 28, 2022.

(51) Int. Cl. F27B 7/02; F27B 7/08; F27B 7/20; F27B 7/38; F27D 17/18

(52) U.S. Cl. CPC F27B 7/02; F27B 7/08; F27B 7/2016; F27B 7/383; F27D 17/18; F27B 2007/025

(57) ABSTRACT

There is provided a kiln assembly comprising a kiln having an external heat supply and a heat treatment chamber configured to contain material to be processed, the heat treatment chamber including a hot section wherein the material flowing therein is heated by the external heat supply; a pre-heating section; a cooling section; and a heat transfer conduit circuit. The pre-heating, hot, and cooling sections are in material communication. The heat transfer conduit circuit forms a closed loop in which circulates a heat transfer fluid and has a pre-heating segment and a cooling segment respectively in heat exchange with the pre-heating and the cooling sections. The heat transfer fluid respectively releases heat to the material located in the pre-heating section and absorbs heat from the material located in the cooling section. There is also provided a method for recovering heat during operation of a kiln assembly.

### CROSS-REFERENCE TO RELATED APPLICATIONS

This application claims priority under 35USC § 119(e) of U.S. provisional patent application Nos. 63/365,967 filed on Jun. 7, 2022 and 63/367,159 filed on Jun. 28, 2022, the specification of which is hereby incorporated by reference.

### FIELD OF THE INVENTION

The present invention relates to a heat recovery system for kilns, in particular to a system recovering heat from high-temperature products exiting the kiln and transferring the recovered heat to preheat a kiln feed material. It also relates to a method for recovering heat from material processed inside a kiln to heat a kiln feed material.

### BACKGROUND

Kilns are used for various solid-processing operations (drying, calcination, sintering, annealing, etc.) in industries such as cement, metallurgy, building materials, glass making, etc. These operations are energy-intensive, and the implementation of waste-heat recovery systems can reduce primary energy consumption and therefore the operating costs and the carbon footprint of the solid-processing operation.

The material processed inside kilns, typically in a solid state, can reach temperatures of up to about 1500° C. and the kiln product is generally cooled prior to further handling or processing steps. The kiln product contains potentially recoverable heat, which can be a waste of the manufacturing process if not recycled or recovered.

To cool the kiln product prior to further handling, direct or indirect cooling methods can be used. For instance, direct cooling methods involve sprinkling water on the kiln product, in a solid state, thereby transferring heat from the kiln product to water, which undergoes into a phase change as low-pressure steam. Alternatively, indirect heat transfer can be carried out using screw conveyors to cool the kiln product, in a solid state, and simultaneously recover heat in a relatively low temperature cooling medium such as cooling water or oil, contained in a special trough jacket and/or through the pipe and hollow flights of the screw conveyor.

Another direct cooling methods involve direct cooling using countercurrent air (or gas) blowing. The heat transfer coefficient between the solid particles and air is generally around 5-83 W·m²·K⁻¹. However, this direct cooling method can be challenging for material containing fine powders due to the entrainment or if an inert processing atmosphere must be maintained due to chemical in stability of the material in contact with air. This direct cooling method can be used, for instance, in grate coolers. The heat contained in the hot air/gas can then be used preheat the kiln feed or as a heat supply for other sections of the industrial process (for instance, heating water). However, as mentioned above, this direct heat recovery method is not suitable for feed and/or product material containing fine particles, which can be entrained in the air/gas stream.

Known heat-recovery systems for other industrial furnaces, such as moving beds or fluidized beds, use working fluids such as water/steam, or supercritical fluids circulating in internal heat exchangers such as tube banks, shell plates, etc. which surfaces are either in direct contact with the hot material flowing in the bed or with the heated air provided by forced convection over the processed material, i.e. fan blowing air onto the hot material, such as solids. While these systems can show typically higher heat transfer coefficients (about 500 W·m²·K⁻¹), using working fluids such as supercritical CO₂ or water/steam requires high-pressure-rated equipment which adds to the costs and complexity of the design and the operation.

In general, indirect cooling and heat recovery systems convey recovered energy to other sections of the plant where heat can be used for other purposes such as water heating or power-generating cycles. Carrying heat to other plant sections can complexify the plant layout and make the operation and the maintenance more difficult.

Besides, none of the above-mentioned heat recovery techniques offers an effective use of the recovered heat to preheat the feed of the same kiln. Currently, efficient heat recovery systems have a large footprint and can face some environmental and technical challenges, especially when it comes to fine material processing.

There is thus a need for a new heat recovery system and an associated heat recovery method with a smaller footprint and which can be used for processes wherein fine materials are handled.

### BRIEF SUMMARY

It is therefore an aim of the present invention to address the above-mentioned issues.

There is provided a heat recovery method wherein heat from a hot kiln product, in a solid state, leaving a hot zone of a kiln (i.e. a main heating zone) is recovered and used to preheat a feed entering the same kiln. There is also provided a kiln including an integrated heat recovery system. The heat recovery system can be used with several kiln types including direct and indirect heated drums, rotary drums or other kiln types.

According to a general aspect, there is provided a kiln assembly comprising: a kiln and a heat recovery system. The kiln includes a vessel having a feed inlet and a product outlet and being dividable into a pre-heating section downstream of the feed inlet, a cooling section upstream of the product outlet, and a hot section located between the pre-heating section and the cooling section. The heat recovery system includes a heat transfer conduit circuit; a heat transfer fluid contained inside the heat transfer conduit circuit, and a fluid circulating device to circulate the heat transfer fluid inside the heat transfer conduit circuit, the heat transfer conduit circuit having a cooling segment in heat exchange communication with the vessel in the cooling section thereof for the heat transfer fluid to absorb heat from the cooling section of the vessel, a pre-heating segment in heat exchange communication with the vessel in the pre-heating section thereof for the heat transfer fluid to release heat to the pre-heating section of the vessel, a first transfer segment connecting an outlet of the pre-heating segment to an inlet of the cooling segment, and a second transfer segment connecting an outlet of the cooling segment to an inlet of the pre-heating segment.

In an embodiment, each one of the cooling segment and the pre-heating segment comprises a jacket respectively in the cooling section and the pre-heating section. In an embodiment, the jacket is mounted to the vessel.

In an embodiment, the kiln is a rotary kiln and the vessel comprises a shell and each one of the cooling segment and the pre-heating segment is mounted externally to the shell of the vessel.

In an embodiment, each one of the cooling segment and the pre-heating segment is at least partially embedded in the vessel of the kiln.

In an embodiment, the vessel defines a heat treatment chamber and the heat transfer conduit circuit is free of segment exposed in the heat treatment chamber.

In an embodiment, the heat recovery system further comprises an insulating layer with the heat transfer conduit circuit being at least partially contained in the insulating layer. The insulating layer can be located outwardly to the vessel and at least partially surround same.

According to another general aspect, there is provided a kiln assembly comprising: a kiln having an external heat supply and a heat treatment chamber configured to contain material to be processed, the heat treatment chamber including a hot section wherein the material flowing therein is heated by the external heat supply; a pre-heating section located upstream of the hot section and being in material communication therewith; a cooling section located downstream of the hot section and being in material communication therewith, the material to be processed flowing sequentially in the pre-heating section, the hot section, and the cooling section; and a heat transfer conduit circuit forming a closed loop in which circulates a heat transfer fluid, the heat transfer conduit circuit having a pre-heating segment in heat exchange with the pre-heating section and a cooling segment in heat exchange with the cooling section wherein the heat transfer fluid respectively releases heat to the material located in the pre-heating section and absorbs heat from the material located in the cooling section.

In an embodiment, the kiln is a rotary kiln and comprises: a vessel having a feed inlet and a product outlet and being dividable into the pre-heating section downstream of the feed inlet, the cooling section upstream of the product outlet, and the hot section located between the pre-heating section and the cooling section. The kiln assembly can further comprise a fluid circulating device to circulate the heat transfer fluid inside the heat transfer conduit circuit, and wherein the heat transfer conduit circuit further comprises a first transfer segment connecting an outlet of the pre-heating segment to an inlet of the cooling segment and a second transfer segment connecting an outlet of the cooling segment to an inlet of the pre-heating segment. Each one of the cooling segment and the pre-heating segment comprises a jacket respectively in the cooling section and the pre-heating section. The jacket can be mounted to the vessel. At least one of the jacket of the cooling segment and the pre-heating segment can be a half-pipe jacket. The vessel can comprise a shell and each one of the cooling segment and the pre-heating segment is mounted externally to the shell of the vessel. Each one of the cooling segment and the pre-heating segment can be at least partially embedded in the vessel of the rotary kiln. The heat transfer conduit circuit can be free of segment exposed in the heat treatment chamber.

In an embodiment, the pre-heating section comprises a screw heater mounted upstream to the kiln. The pre-heating segment can comprise at least one of a jacket, a channel extending through a shaft of a screw of the screw heater, and a chamber extending through at least one flight of the screw of the screw heater. The jacket can be mounted to the screw heater. The cooling section can comprise a screw cooler mounted downstream to the kiln.

The cooling segment can comprise at least one of a jacket, a channel extending through a shaft of a screw of the screw heater, and a chamber extending through at least one flight of the screw of the screw heater. The jacket can be mounted to the screw heater.

The heat transfer conduit circuit can further comprise a first transfer segment connecting an outlet of the pre-heating segment to an inlet of the cooling segment and a second transfer segment connecting an outlet of the cooling segment to an inlet of the pre-heating segment.

In an embodiment, the pre-heating section comprises a pre-heating drum mounted upstream to the hot section. The pre-heating segment can comprise a jacket mounted to the pre-heating drum. The jacket can be a split-coil jacket.

In an embodiment, the cooling section comprises a cooling drum mounted downstream to the hot section. The cooling segment can comprise a jacket mounted to the cooling drum. The jacket can be a split-coil jacket.

The heat transfer conduit circuit can further comprise a first transfer segment connecting an outlet of the pre-heating segment to an inlet of the cooling segment and a second transfer segment connecting an outlet of the cooling segment to an inlet of the pre-heating segment.

In an embodiment, the kiln assembly can further comprise an insulating layer at least partially covering the heat transfer conduit circuit.

In an embodiment, the heat transfer fluid remains in a liquid state in an entire operating temperature range of the kiln.

In an embodiment, the heat transfer fluid remains in a liquid state from about 80° C. to about 1000° C.

According to still another general aspect, there is provided a heat recovery system for recycling heat during operation of a kiln assembly including a pre-heating section, a hot section, and a cooling section. The heat recovery system comprises: a heat transfer conduit circuit having a cooling segment mounted to the cooling section of the kiln assembly to be in heat exchange communication therewith, a pre-heating segment mounted to the pre-heating section of the kiln assembly to be in heat exchange communication therewith, and a first and a second transfer segments connecting the cooling and the pre-heating segments to define a closed-loop circulation path; a heat transfer fluid contained inside the heat transfer conduit circuit, and a fluid circulating device to circulate the heat transfer fluid inside the heat transfer conduit circuit.

In an embodiment, the cooling segment comprises a jacket mounted to the cooling section of the kiln assembly and the pre-heating segment comprises a jacket mounted to the pre-heating section of the kiln assembly. At least one of the jacket of the cooling section and the jacket of the pre-heating section can be a half-pipe jacket.

According to a further general aspect, there is provided a method for recovering heat during operation of a kiln assembly including a pre-heating section, a hot section, and a cooling section. The method comprises: Circulating a material sequentially in the pre-heating section, the hot section, and the cooling section of the kiln assembly; Heating the material in the hot section of the kiln assembly; Absorbing heat in the cooling section of the kiln assembly via a heat transfer fluid circulating in a heat transfer conduit circuit defining a closed-loop circulation path and having a cooling segment in heat exchange communication with the cooling section of the kiln assembly; Releasing heat in the pre-heating section of the kiln assembly via the heat transfer fluid circulating in a pre-heating segment of the heat transfer conduit circuit, the pre-heating segment of the heat transfer conduit circuit being in heat exchange communication with the pre-heating section of the kiln assembly; and Continuously circulating the heat transfer fluid in the closed-loop circulation path between the cooling and the pre-heating segments of the heat transfer conduit circuit during operation of the kiln assembly to continuously absorb heat in the cooling section of the kiln assembly and release the absorbed heat in the pre-heating section of the kiln assembly.

In an embodiment, the kiln assembly comprises a rotary kiln including a vessel having a feed inlet and a product outlet and being dividable into the pre-heating section downstream of the feed inlet, the cooling section upstream of the product outlet, and the hot section located between the pre-heating section and the cooling section.

In an embodiment, the heat transfer conduit circuit comprises a first transfer segment connecting an outlet of the pre-heating segment to an inlet of the cooling segment and a second transfer segment connecting an outlet of the cooling segment to an inlet of the pre-heating segment.

In an embodiment, absorbing heat in the cooling section of the kiln assembly comprises circulating the heat transfer fluid in a jacket mounted to the cooling section

In an embodiment, releasing heat in the pre-heating section of the kiln assembly comprises circulating the heat transfer fluid in a jacket mounted to the pre-heating section.

In an embodiment, the pre-heating section comprises a screw heater and wherein circulating the material in the pre-heating section comprises circulating the material in the screw heater. Releasing heat in the pre-heating segment can comprise circulating the heat transfer fluid in at least one of a jacket, a channel extending through a shaft of a screw of the screw heater, and a chamber extending through at least one flight of the screw of the screw heater. The jacket can be mounted to the screw heater.

In an embodiment, the cooling section comprises a screw cooler and wherein circulating the material in the cooling section comprises circulating the material in the screw cooler. Absorbing heat in the cooling segment can comprise circulating the heat transfer fluid in at least one of a jacket mounted to the screw cooler, a channel extending through a shaft of a screw of the screw cooler, and a chamber extending through at least one flight of the screw of the screw cooler.

In an embodiment, circulating a material sequentially in the pre-heating section, the hot section, and the cooling section of the kiln assembly comprises circulating the material sequentially in a pre-heating drum, a hot kiln drum, and a cooling drum. Absorbing heat in the cooling section of the kiln assembly can comprise circulating the heat transfer fluid in a jacket mounted to the cooling drum. Releasing heat in the pre-heating section of the kiln assembly can comprise circulating the heat transfer fluid in a jacket mounted to the pre-heating section.

In an embodiment, continuously circulating the heat transfer fluid in the closed-loop circulation path comprises maintaining the heat transfer fluid in a liquid state in an entire operating temperature range of the kiln assembly.

In an embodiment, the heat transfer fluid is selected from the group consisting of: molten metals, molten salts, and a mixture thereof.

In an embodiment, the heat transfer fluid is selected from the group consisting of: alkali metals, heavy metals, eutectic mixtures, and alloys thereof.

The present document refers to a number of documents, the contents of which are hereby incorporated by reference in their entirety.

### BRIEF DESCRIPTION OF THE FIGURES

FIG. 1 is a schematic perspective view of a rotary kiln including a heat recovery system in accordance with an embodiment;

FIG. 2 is a cross-sectional view of the rotary kiln of FIG. 1;

FIG. 3 is a cross-sectional view of the rotary kiln of FIG. 1 including temperature and tonnage data for example 1;

FIG. 4 is a schematic representation of a kiln assembly including a heat recovery system in accordance with another embodiment, wherein the kiln assembly includes screw conveyors respectively upstream and downstream a feed inlet and a feed outlet of a kiln;

FIG. 5 is a schematic representation of the kiln assembly of FIG. 4 including temperature and tonnage data for example 2;

FIG. 6 is a schematic representation of a kiln assembly including a heat recovery system in accordance with another embodiment, wherein the kiln assembly includes a pre-heating drum and a cooling drum respectively upstream and downstream a hot kiln drum; and

FIG. 7 is a schematic representation of the heat recovery system of FIG. 6 including temperature and tonnage data for example 3.

It will be noted that throughout the appended drawings, like features are identified by like reference numerals.

### DISCLOSURE OF THE INVENTION

Moreover, although the embodiments of the heat recovery system and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the heat recovery system, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value. In the following description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

The present invention relates to a kiln and a kiln assembly including a heat recovery system to recover heat from hot product, mostly in a solid state, leaving a hot zone (or section) and entering a cooling zone (or section) of a kiln/kiln assembly, which can include a rotary kiln, and convey the recovered heat (or thermal energy) to a pre-heating zone (or section) of the same kiln/kiln assembly to heat a feed of the kiln/kiln assembly. The heat exchange is carried out indirectly, i.e., via a heat transfer fluid and heat exchange surfaces. The heat transfer fluid does not contact directly the material processed inside the kiln/kiln assembly.

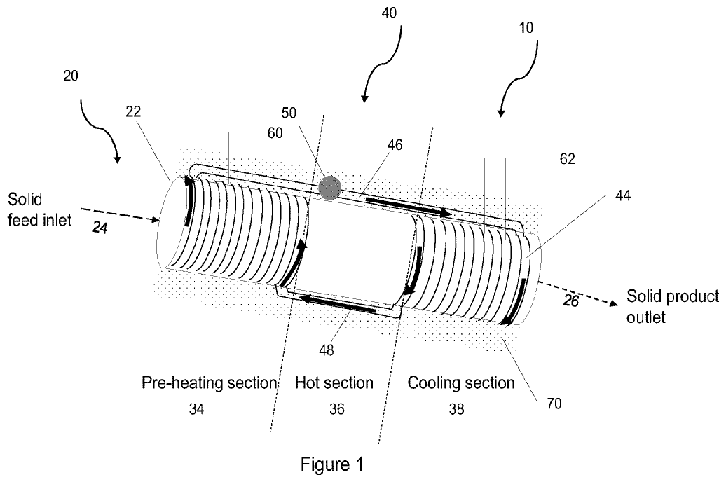

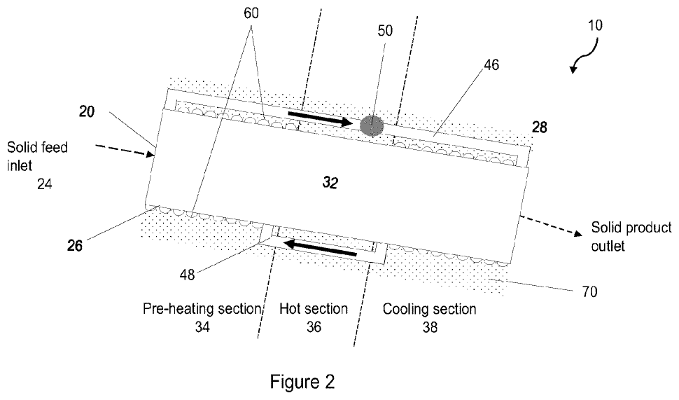

A kiln is a furnace (or a heated enclosure) into which a material is processed, i.e, wherein chemical and/or physical changes occur, through heat (i.e. burning, firing, or drying). The process carried out in the kiln can be a calcination, an organic combustion, a thermal desorption, a sintering, a heat setting, and a reduction roasting. Referring to FIGS. 1 and 2, there is shown that a kiln assembly 10 including the kiln 20. The kiln 20 comprises a vessel 22 (or kiln body) having a feed inlet 24 and a product outlet 26, and an external heat supply (not shown) (i.e., the kiln can be an electric kiln, a gas heated kiln, or a solid carburant kiln (e.g., wood)). The vessel 22 includes a shell 28 and a refractory lining (not shown) extending inwardly from the shell 28 and defining the heat treatment chamber 32 into which the material is processed and flows between the feed inlet 24 and the product outlet 26. As shown in FIGS. 1 and 2, the vessel 22 of the kiln 20 can be inclined slightly to the horizontal. In such non-limitative embodiment, the feed inlet is located at an upper end of the kiln 20. Furthermore, the vessel 22 can be rotatable about its longitudinal axis, i.e. a rotary kiln.

The heat recovery system can be used with any kiln types, including rotary kilns such as and without being limitative to rotary drum, variable diameter rotary kiln, full diameter rotary kiln. Kilns with any drive assembly type can be used such as without being limitative to chain and sprocket, gear and pinion, friction, direct. Rotary kilns with any bed motion in the cross-section plane can be used such as and without being limitative to slipping, slumping, rolling, cascading, and centrifuging.

The kiln can optionally comprise any of the following main accessories such as and without being limitative to knocking systems, trommel screen, liners, leaf seals, graphite seals, machined bases screw conveyor feeder, automatic gear lubrication system, exhaust handling equipment, ductwork, and various burner configurations components for increasing efficiency (flights, dams, bed disturbers, etc.).

The kiln can be either direct fired or indirect fired either using fuel such as, and without being limitative to, gas (e.g., natural gas or propane), coal, fuel oil, biogas, mixed-fuel, or by electricity or waste heat. The kiln exhaust system can be co-current or counter current. The main heat transfer mechanism to the kiln can be via radiation, convection, or conduction.

The kiln can either be used for wet or dry processes. Non limitative examples of kiln applications are kaolin, activated carbon, alumina, catalysts, cement, contaminated soil, charcoal production, electronic waste, lime, petroleum coke, phosphate ore, pigments, precious metals, proppants, reduction roasting, pyrolysis, silica, ceramics, specialty chemicals, waste lime sludge, waste materials.

In the non-limitative embodiment shown in FIGS. 1 and 2, along the vessel longitudinal axis and between the feed inlet 24 and the product outlet 26, the heat treatment chamber 32 can be sequentially divided into a pre-heating section 34, a hot section 36, and a cooling section 38, as will be described in more details below.

The pre-heating section 34 can include a drying section and is located adjacent to the feed inlet 24. The hot section 36 can include a decomposition section, an exothermic reaction section, a firing section, and/or a burning section, if any. The hot section 36 can be directly or indirectly heated by an external heat supply, such as gas, solid carburant, or electric heating. The cooling section can also be referred to as a lower transition section and is located adjacent to the product outlet 26. The material processed in the kiln 20 sequentially flows from the pre-heating section 34 to the hot section 36, and, then, to the cooling section 38. Thus, the pre-heating section 34 and the hot section 36 are in material communication. Similarly, the hot section 36 and the cooling section 38 are in material communication.

In the embodiment shown in FIGS. 1 and 2, in addition to the kiln 20, the kiln assembly 10 further includes a heat recovery system 40. The heat recovery system 40 is mounted to the vessel 22 with some parts being embedded therein and other parts being located outwardly thereof.

The heat recovery system 40 can include heat exchange surface (not shown) mounted to the shell 28 or embedded in the refractory lining in the pre-heating section 34 and the cooling section 38, the purpose of which will be described in more details below.

The heat recovery system 40 also includes a heat transfer conduit circuit 44 including at least one pipe (or conduit) mounted to the vessel 22 and in which circulates a heat-transfer fluid. The heat transfer conduit circuit 44 has segments in contact with the vessel 22 in both the pre-heating section 34 and the cooling section 38. In the non-limitative embodiment shown in FIGS. 1 and 2, the conduit 44 is coiled over the shell 28, outwardly thereof, in both the pre-heating section 34 and the cooling section 38. Therefore, the conduit 44 coiled over the shell 28 is each one of the pre-heating section 34 and the cooling section 38 forms a jacket such as a half-pipe jacket (i.e., a split coil jacket) and, more particularly, a pre-heating jacket 60 and a cooling jacket 62. It is appreciated that, in an alternative embodiment (not shown), the pre-heating and/or the cooling jackets can be a conventional jacket, i.e. an outer layer covering the shell with the heat transfer fluid flowing between an outer shell surface and an inner surface of the outer layer. In an alternative embodiment, the shell of the kiln 20 itself is at least partially defined by the conduit 44 coiled to form a vessel. In such embodiment, the heat transfer between the heat transfer chamber 32 and the heat transfer fluid contained in the conduit 44 occurs solely via the conduit 44 forming the shell of the kiln 20.

In an embodiment, the pre-heating section 34 and the cooling section 38 respectively correspond to the sections of the kiln 20 that are in contact with the pre-heating jacket 60 and a cooling jacket 62. If the kiln assembly 10 includes other types of heat exchanger than a jacket, the pre-heating section 34 and the cooling section 38 respectively correspond to the sections of the kiln assembly 10 that are in contact with the heat exchangers. The pre-heating section 34 corresponds to the section of the kiln assembly 10 wherein material is processed and including a heat exchanger releasing heat to the material being processed. The cooling section 38 corresponds to the section of the kiln assembly 10 wherein material is processed and including a heat exchanger absorbing heat from the material being processed.

The pipes/conduits are made of high temperature steels, such as and without being limitative to austenitic steels (SS-304, 316L, 316LN), martensitic steels (T91), alumina forming austenitic alloys (AFA) or oxide-dispersion strengthened steels (FeCrAl, FeCr, 12CrODS, 9CrODS). The person skilled in the art will recognize that those are mentioned as examples only and various piping materials with the suitable mechanical properties and corrosion resistance can be used depending on the operating conditions of the furnace, the configuration of the heat recovery system, and the choice of the heat-transfer fluid.

The pre-heating jacket 60 and the cooling jacket 62 are in fluid communication, i.e. the heat-transfer fluid flows in both segments of the coiled conduit, through transfer segments 46, 48. The transfer segment 46 of the heat transfer conduit circuit 44 connects an outlet of the pre-heating jacket 60 with an inlet of the cooling jacket 62. The transfer segment 48 connects an outlet of the cooling jacket 62 with an inlet of the pre-heating jacket 60. Thus, the transfer segments 46, 48 interconnect the pre-heating jacket 60 and the cooling jacket 62 to form a closed-loop heat transfer conduit circuit.

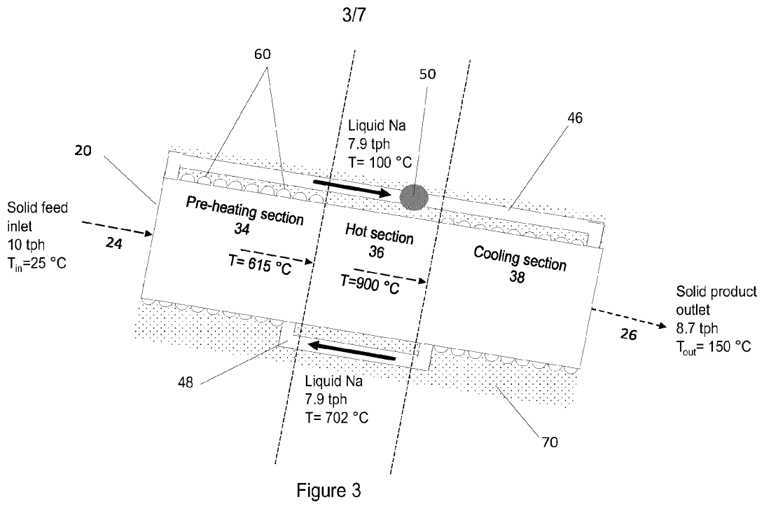

In the embodiment shown, in both the pre-heating section 34 and the cooling section 38, the heat transfer fluid flows counter-current with the material processed in the heat treatment chamber 32 of the kiln 20. In FIGS. 1 to 3, the direction of the heat transfer fluid is exemplified by the arrows. In each jacket 60, 62, the heat transfer fluid flows from an end closer to the product outlet 26 of the kiln 20 towards an end closer to the feed inlet 24 of the kiln 20 while the material flows from the feed inlet 24 towards the product outlet 26. Thus, in the pre-heating section 34, the heat transfer fluid, having absorbed heat in the cooling section 38, first contact the hottest material of this section 34, just before entering the hot section 36. In the cooling section 38, the heat transfer fluid, having released heat to the material in the pre-heating section 34, first contact the coolest material of this section 38, just before exiting the heat treatment chamber 32. It is appreciated that, in an alternative embodiment, in one or both of the pre-heating section 34 and the cooling section 38, the heat transfer fluid can flow co-current with the material processed in the heat treatment chamber 32 of the kiln 20.

In the embodiment shown, the kiln 20 also includes an insulating layer 70 and, more particularly, an insulating outer layer wrapped around a peripheral wall of the shell 28. In the non-limitative embodiment shown, the pre-heating jacket 60, the cooling jacket 62, and the transfer segments 46, 48 of the heat transfer conduit circuit 44 are embedded in the insulating layer 70. The insulating layer 70 reduces the heat losses to the kiln surroundings. In the embodiment shown, the insulating layer 70 is a sleeve surrounding an assembly including the pre-heating jacket 60, the cooling jacket 62, and the transfer segments 46, 48. In an alternative embodiment (not shown), the insulating layer 70 can surround the heat transfer conduit circuit forming the pre-heating jacket 60, the cooling jacket 62, and the transfer segments 46, 48.

The insulating layer 70 is made of any insulating refractories materials such as and without being limitative to including high-alumina, calcium silicate, mullite, cordierite mullite, clay, MgO—Al₂O₃ spinel castable refractory or bricks.

The heat recovery system 40 also includes a fluid circulating device 50, such as a pump, to circulate the heat-transfer fluid inside the heat transfer conduit circuit at a suitable flowrate. The fluid transfer device 50 circulates the heat-transfer fluid between the cooling jacket 62 wherein the heat-transfer fluid extracts heat from the heat treatment chamber 32 (and the material contained therein) and the pre-heating jacket 60 wherein heat contained in the heat-transfer fluid is released inside the heat treatment chamber 32 and to the material contained therein. In an embodiment, a guard heater (not shown) can be provided upstream of the fluid circulating device 50 to protect the latter against high-viscosity fluid or solid particles formed during abnormal cooling in certain operation conditions, such as start up and shut down, for instance.

In the embodiment shown, the fluid circulating device 50 is mounted upstream to the cooling jacket 62, in which the temperature of the heat-transfer fluid will increase. More particularly, it is mounted to the transfer segment 46 containing heat-transfer fluid having released heat to the pre-heating section 34, i.e. the transfer segment containing heat transfer fluid at a lower temperature, to minimize the exposure of the fluid circulating device 50 to high temperature heat transfer fluid. However, it is appreciated that, in an alternative embodiment (not shown), the fluid circulating device 50 can be mounted to the transfer segment 48 or both transfer segments 46, 48 can have a fluid circulating device 50 mounted thereto.

The heat transfer conduit circuit 44 can include a plurality of pipes/conduits configured in a parallel configuration or a single pipe/conduit.

In some embodiment, the segments of the heat transfer conduit circuit 44 defining the pre-heating jacket 60 and the transfer segments 46, 48 and the fluid circulating device 50 can be heat traced to melt the heat transfer fluid during start-up of the kiln 20. Alternatively, a specific start up (warm-up) procedure can be performed to melt the heat transfer fluid safely before feeding the heat transfer conduit circuit of the kiln 20 assembly.

In an embodiment, the heat-transfer fluid (or working fluid or heat transfer medium) is selected to remain in a liquid (or molten) state in an entire operating temperature range of the kiln, i.e. to prevent phase changes. In other words, the heat-transfer fluid is selected to not decompose, solidify or boil within the kiln operating temperature range. In a non-limitative embodiment, the heat-transfer fluid is in a liquid (molten) state in a temperature range extending from about 80° C. to about 1000° C.

In some embodiments, a molten metal, a molten salt or a mixture thereof can be used as heat-transfer fluid. Molten metals are characterized by high thermal conductivities, low viscosities, high chemical stabilities, and high boiling point that make them suitable to extract heat from the cooling section 38 of the vessel 22 and release heat in the pre-heating section 34 of the vessel 22 without undergoing a phase change. In some embodiment, the heat-transfer fluid is selected as to avoid vaporization in the kiln operating temperature range. Vaporization of the heat-transfer fluid would require high-pressure-rated pipes and complexifies pumping and transportation, thereby increasing the heat transfer system costs.

For instance, and without being limitative, liquid metals or alloys, eutectic mixtures such as alkali metals (i.e., sodium (Na), Potassium (K) Lithium (Li)) or heavy metals and their alloys for example Tin (Sn), or LBE (i.e., Lead-Bismuth Eutectic), can be used as heat-transfer fluid and circulate inside the heat transfer conduit circuit 44. For instance, and without being limitative, the eutectic mixture of molten metals such as 50% Na and 50% K can be used to avoid solidification at room temperature. The person skilled in the art will recognize that those are mentioned as examples only and various heat-transfer fluids with the suitable physicochemical properties can be used depending on the operating conditions of the furnace.

The heat transfer fluid is not in direct contact with the internal atmosphere of the kiln, i.e. with the heat treatment chamber 32. Heat exchanges between the heat treatment chamber 32 occurs through the refractory lining and the shell 28. Thus, the heat transfer between the material contained in the kiln (or the kiln assembly) and the heat transfer fluid is an indirect heat exchange/transfer.

It is appreciated that the shape and the configuration of the kiln to which the heat recovery system is mounted can vary from the embodiment shown. Furthermore, the heat recovery system 40 can also vary from the embodiment shown. Heat exchange between the heat recovery system 40 and the heat treatment chamber 32 and the material contained therein occurs through a surface of the kiln 20 delimitating the heat treatment chamber 32, such as an internal surface of the refractory lining or the shell 28.

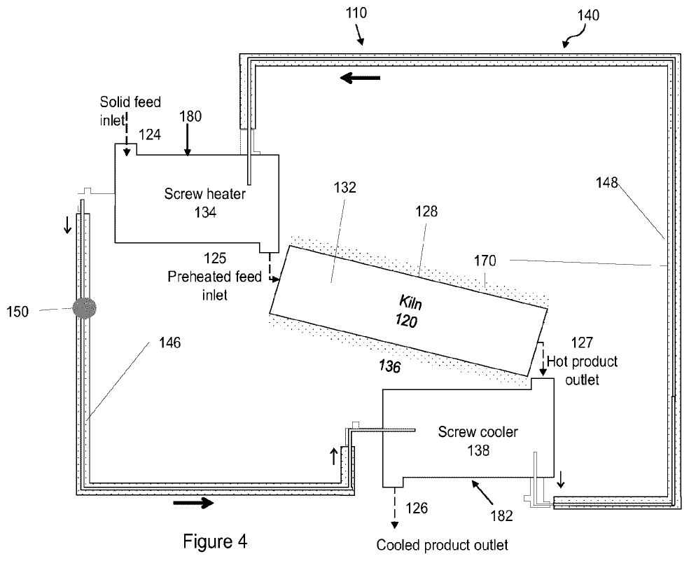

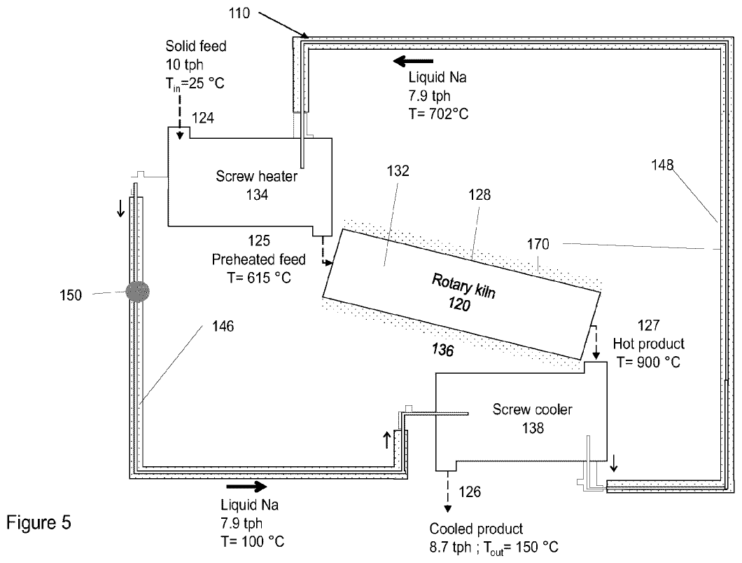

The heat recovery system is applicable to other kiln types. Non-limitative examples will be described in reference to FIGS. 4 to 7. For instance, in FIGS. 4 and 5, two indirect heat transfer screw conveyors are added before and after the main kiln in which the heat transfer liquid (i.e., liquid sodium) flows into the conveyor located after the kiln to recover/absorb the heat and cool the process material and then flow into the conveyor located before the main kiln to deliver/release the heat and preheat the process material before entering the main kiln.

By recovering heat from the material and the heat treatment chamber 32 in the cooling section 38 and transferring it to the material and the heat treatment chamber 32 of the pre-heating section 38 lowers the net heating load of the overall system. In some non-limitative embodiment, up to about 50% of the required sensible heat can be recovered. Furthermore, in some embodiments, by further enabling an effective pre-heating of the material, at least one of a length of the hot section 36 and the operating costs associated with the hot section 36 can be reduced. The use of jackets 60, 62 surrounding the shell 28 or heat exchangers embedded in the shell 28 or refractory lining along most of the pre-heating section 34 and the cooling section 38 can reduce the insulation requirement. The jackets 60, 62 create a functional barrier against heat losses by continuously absorbing heat from the heat treatment chamber 32 (and the material contained therein) and rejecting heat to the heat treatment chamber 32 and the material contained therein.

To further promote heat transfer between the heat treatment chamber 32 (and the material contained therein, the kiln 20 can include flights or teeth extending from the shell 28 or the refractory lining inside the heat treatment chamber 32 and contacting the material being processed.

In the embodiment shown, the heat recovery system 40 recovers heat from the heat treatment chamber 32 (and the material contained therein) of a kiln 20 and releases the recovered heat to the heat treatment chamber 32 and the material contained therein of the same kiln 20.

Such a system does not impose any restriction for specific flow direction of air or flue gas inside the kiln. Besides, the heat recovery is not affected by the nature, size, toxicity, or other feature of the material being processed and it does not generate any dust and does not require extra machinery to recover heat from fine solid particles.

### Example 1. Thermal Treatment of Iron Oxide Material

One example of a kiln including a heat recovery system in accordance with a non-limitative embodiment is described herein below and schematized in FIGS. 1 to 3.

For example, an iron oxide-rich material (i.e. the feed material) is sent to a rotary kiln 20 for a thermal treatment at 900° C. The feed mass flow rate is 10 metric tonnes per hour. The feed enters the kiln 20 at ambient temperature (25° C.) and has a heat capacity of 0.85 kJ·kg⁻¹·K⁻¹. The hot section 36 constitutes the reaction zone in which a preheated gas at a temperature of 900° C., is injected at a flow rate of 227 kg/h to react with the ferric oxides of feed material. In this embodiment, both the preheating and the cooling zone are jacketed with a split-coil jacket in which a heat transfer fluid and, more particularly, is liquid sodium (Na) is flowing counter-currently versus the process material (or solid) flow.

The relevant physical properties of liquid sodium are presented in the Table 1 below.

TABLE 1

| | | Normal boiling | Average Thermal |
|---|---|---|---|
| Cp of liquid | Melting point | point | Conductivity |
| (kJ · kg⁻¹ · K⁻¹) | (C.) | (C.) | (W/m · K) |
| 1.3 | 98° C. | 883° C. | 70 |

The feed material enters the kiln 20 at ambient temperature, the pre-heating section 34 of the rotary kiln 20 wherein it is preheated to a temperature of 615° C. by heat exchange with the liquid sodium flowing counter-currently in the half-pipe pre-heating jacket 60 at a flowrate of 7876 kg/h. The liquid sodium temperature at an inlet of the pre-heating jacket 60 is 702° C. The cold liquid sodium leaving the pre-heating jacket 60 at a temperature of 100° C. is pumped to the cooling jacket 62 to cool the processed material exiting the hot section 36.

The preheated material enters the hot section 36 and is contacted by the preheated gas. Heat is provided to achieve a temperature of 900° C. in the hot section 36. The heat for heating the preheated gas can be provided either directly or indirectly, by means of fired gas or electricity, for instance. In this case, the excess, and the flue gases are drawn out of the hot section 36 and can be sent to another system for heat recovery. The net heat requirements of the hot section 36, including the sensible heat (from 615° C. to 900° C.) and the heat of reactions (1491 KW) are calculated to be 2425 kW.

The reacted material (Cp=1.1 kJ·kg⁻¹·K⁻¹) leaving the hot section 36 at a flow rate of 8.7 metric tonnes/hour and entering the cooling section 38 of the kiln 20 are cooled to 150° C. by the cold liquid sodium (100° C.) pumped from the pre-heating section 34 and flowing counter-currently. The liquid sodium leaves the cooling jacket 62 at T=702° C. and is recirculated to the pre-heating jacket 60.

Without the heat recovery system 40 described in this embodiment, the total heat requirements for the same kiln 20 including sensible heat (from 25° C. to 900° C.) and the heat of reactions (1491 KW) are about 4132 KW. The heat recovered using the heat recovery system 40 as described in this embodiment thus represents net energy savings of about 40% of the total heat requirements.

Referring now to FIG. 4, there is shown an alternative embodiment of the heat recovery system for a kiln assembly wherein the features are numbered with reference numerals in the 100 series which correspond to the reference numerals of the previous embodiment.

The kiln assembly 110 includes two screw conveyors 180, 182 mounted respectively upstream and downstream of a kiln 120, which can be, without being limited to, a rotary kiln. The heat recovery system 140 is at least partially contained/mounted to the screw conveyors which are indirect heat-transfer screw conveyors. The indirect heat-transfer screw conveyors define respectively the pre-heating section 134 and the cooling section 138. A first one of the indirect heat-transfer screw conveyors is a screw feeder 180 (or screw heater) mounted upstream to the kiln 120 and serves the purpose of pre-heating the feed material before feeding it to the kiln 120. The second screw conveyor 182, can be referred to as a screw cooler, is mounted downstream to the kiln 120 and cools the hot material exiting the kiln 120.

The feed material enters the screw heater 180 via the feed inlet 124 and is heated therein by a heat-transfer fluid that circulates in a closed-loop heat transfer conduit circuit between the screw heater 180 and the screw cooler 182. The heated feed material is transferred from an outlet of the screw heater 180 to a preheated feed inlet 125 of the kiln 120. The feed material is processed in the heat treatment chamber 132 of the kiln 120 and outputted at a hot product outlet 127. The hot product is then introduced into the cooler screw 182 via its inlet wherein it is cooled by heat transfer via the heat transfer fluid. The cooled product is withdrawn via a cooled product outlet 126 of the cooler screw 182. Thus, the material processed in the kiln assembly 110 sequentially flows from the pre-heating section 134 to the hot section 136, and, then, to the cooling section 138. The pre-heating section 134 and the hot section 136 are in material communication. Similarly, the hot section 136 and the cooling section 138 are in material communication.

The kiln 120 defines the hot section and includes a hot kiln drum wherein material processed therein is heated via the external heat supply.

The heat transfer fluid circulates in a closed-loop heat transfer conduit circuit between the screw heater 180, wherein it releases heat to the feed material, and the screw cooler 182, wherein it absorbs heat from the hot product. The heat transfer fluid is transferred from the screw heater 180 to the screw cooler 182 via heat transfer segment 146 and from the screw cooler 182 to the screw heater 180 via heat transfer segment 148. Thus, the heat transfer fluid flows continuously in the closed-loop conduit circuit (or a closed-loop heat transfer system).

The closed-loop heat transfer system can include a fluid transfer device 150, such as and without being limitative a pump, that circulates the heat-transfer fluid between the screw cooler 182 wherein the heat-transfer fluid extracts heat and the screw heater 180 wherein heat contained in the heat-transfer fluid is released to the material contained therein. In the non-limitative embodiment shown in FIG. 4, the heat transfer device 150 is mounted to the heat transfer segment 146 but it is appreciated that it can be mounted to the heat transfer segment 148 or to both heat transfer segments 146, 148.

Similar to the above-described embodiment, a guard heater (not shown) can be provided upstream of the fluid circulating device 150 to protect the latter against high-viscosity fluid or solid particles formed during abnormal cooling in certain operation conditions, such as start up and shut down, for instance.

In the embodiment shown, in both the screw heater 180 and the screw cooler 182, the heat transfer fluid flows counter-current with the material conveyed in the screw heater and cooler 180, 182, as exemplified by the arrows. In the screw heater 180, the heat transfer fluid can flow inside a jacket surrounding the shell of the screw heater 180 (such a conventional or a half-pipe jacket), through a pipe/conduit forming a jacket surrounding the shell of the screw heater 180, through a shaft of the screw extending inside a chamber of the screw heater 180 or inside the flights of the screw, for instance. As for the embodiment shown in FIGS. 1 and 2, in an alternative embodiment, the shells of the screw heater 180 and/or the screw cooler 182 themselves can at least partially defined by the coiled conduit 144. In such embodiment, the heat transfer between the material contained in the screw heater/cooler 180/182 and the heat transfer fluid contained in the conduit 144 occurs solely via the conduit 144 forming the shell of the screw heater/cooler 180/182.

The heat transfer fluid flows from an end closer to the pre-heated feed output 125 towards an end closer to the feed inlet 124 while the feed material flows from the feed inlet 124 towards the pre-heated feed outlet 125. Thus, in the screw heater 180, the heat transfer fluid, having absorbed heat in the screw cooler 182, first contact the hottest material of this pre-heating section 134.

Similarly, for the cooling section 128 including the screw cooler 182, the heat transfer fluid can flow inside a jacket surrounding the shell of the screw heater 180 (such a conventional or a half-pipe jacket), through a pipe/conduit forming a jacket surrounding the shell of the screw cooler 182, through a shaft of the screw extending inside a chamber of the screw cooler 182 or inside the flights of the screw, for instance. The heat transfer fluid flows from an end closer to a cooled product outlet 126 towards an end closer to the hot product outlet 127 while the material flows from the hot product inlet 127 towards the cooled product outlet 126. In the screw cooler 182, the heat transfer fluid, having released heat to the material in the screw heater 180, first contact the coolest material of this cooling section 138.

It is appreciated that, in an alternative embodiment, in one or both of the screw heater 180 and the screw cooler 182, the heat transfer fluid can flow co-current with the material being conveyed.

For the screw heater 180 or the screw cooler 182, if the heat transfer fluid flows through the shaft and/or the flights of the screw, it is appreciated that the latter are at least partially hollowed to allow a flow of the heat transfer fluid therein. For instance, the heat transfer fluid can flow through a channel extending through the shaft of the screw of the screw heater 180 and/or the screw cooler 182. The heat transfer fluid can also flow inside chamber(s) defined in at least one of the flight(s) of the screw of the screw heater 180 and/or the screw cooler 182.

It is appreciated that different configurations of the heat-transfer screw conveyors (used as screw heater and/or screw cooler) exist depending on where the heat-transfer fluid is allowed to flow through such as and without being limitative to jacketed screw conveyor, hollow-shaft screw conveyor, and hollow-flight screw conveyor. The person skilled in the art will recognize that other configurations and combinations of the above configurations can be tailored to suit the heat transfer requirements of the application sought.

Using a screw conveyor as pre-heating and/or cooling sections, can be advantageous in that the mixing of the conveyed material increases the heat transfer with the heat transfer fluid that is circulated in the jacket, the shaft, or the hollow flighting of the auger.

As for the above-described embodiment, it is appreciated that the kiln 120 also includes an insulating layer 170 and, more particularly, an insulating outer layer wrapped around a peripheral wall of the kiln shell 128.

In the non-limitative embodiment shown, the transfer segments 146, 148 of the heat transfer conduit circuit 144 of the heat transfer conduit circuit are also embedded in an insulating material (or surrounded by an insulating material). The insulating layer 170 and insulating material reduces the heat losses to the kiln and pipe surroundings. In the embodiment shown, the insulating layer 170 is a sleeve surrounding an assembly including the transfer segments 146, 148. In an alternative embodiment (not shown), the insulating layer 170 can surround the screw heater 180, the screw cooler 182 and the transfer segments 146, 148.

Once again, in the kiln assembly 110, the heat transfer fluid is not in direct contact with the material being processed. Heat exchanges between the material being processed occurs through a body of the screw heater 180 and the screw cooler 182. Thus, the heat transfer between the material contained in the kiln assembly and, more particularly, the screw heater 180 and the screw cooler 182 and the heat transfer fluid is an indirect heat exchange/transfer.

Furthermore, as for the embodiment described in reference to FIGS. 1 and 2, the heat recovery system 140 of the kiln assembly 110 recovers heat from the screw cooler 182 and the material contained therein of a kiln assembly 110 and releases the recovered heat to the screw heater 180 and the material contained therein of the same kiln assembly 110.

### Example 2. Thermal Treatment of Iron Oxide Material

Turning now to FIG. 5, one example of a kiln including a heat recovery system, in accordance with the embodiment shown in FIG. 4 is described. The process parameters are similar to the ones of Example 1, described above and are summarized in Table 2 below.

TABLE 2

| Process variables | Process parameters | |
|---|---|---|
| Thermal treatment temperature inside | 900° | C. |
| the kiln | | |
| Feed mass flow rate | 10 | metric tonnes per hour |
| Feed material temperature at screw | 25° | C. |
| heater inlet or the pre-heating drum inlet | | |
| Heat capacity of feed material | 0.85 | kJ · kg⁻¹ · K⁻¹ |

| | |
|---|---|
| Heat transfer fluid | Liquid sodium (Na) |

In this embodiment, both the screw heater 180 and the screw cooler 182 are jacketed with a split-coil jacket in which a heat transfer fluid and, more particularly, is liquid sodium (Na) is flowing counter-currently versus the process material (or solid) flow. The relevant physical properties of liquid sodium are presented in the Table 1 above.

The feed material enters the screw heater 180 at ambient temperature wherein it is preheated to a temperature of 615° C. by heat exchange with the liquid sodium flowing counter-currently at a flowrate of 7.9 t/h. The liquid sodium temperature at an inlet of the screw heater 180 is 702° C. The cold liquid sodium leaving the screw heater 180 at a temperature of 100° C. is pumped to the screw cooler 182 to cool the processed material exiting the kiln 120, which in this embodiment is a rotary kiln.

The preheated material enters the rotary kiln 120 and is contacted by the preheated gas. Heat is provided to achieve a temperature of 900° C. in the rotary kiln 120. The heat for heating the preheated gas can be provided either directly or indirectly, by means of fired gas or electricity, for instance. In this case, the excess, and the flue gases are drawn out of the rotary kiln 120 and can be sent to another system for heat recovery.

The reacted material (Cp=1.1 kJ·kg⁻¹·K⁻¹) leaving the rotary kiln 120 at a flow rate of 8.7 metric tonnes/hour and entering the screw cooler 182 of the kiln 120 are cooled to 150° C. by the cold liquid sodium (100° C.) pumped from the screw heater 180 and flowing counter-currently. The liquid sodium leaves the screw cooler 182 at T=702° C. and is recirculated to the screw heater 180.

The heat requirement savings are similar to the ones described above in Example 1, i.e. net energy savings of about 40% of the total heat requirements.

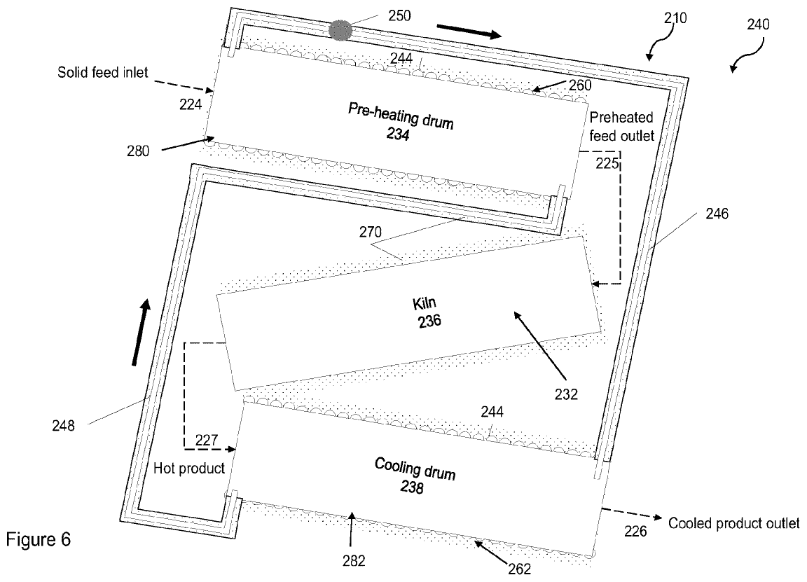

Referring now to FIG. 6, there is shown an alternative embodiment of a kiln assembly including a heat recovery system in combination with a kiln wherein the features are numbered with reference numerals in the 200 series which correspond to the reference numerals of the previous embodiment. The heat recovery system 240 is similar to the one described above in reference to FIG. 4, except that, in the kiln assembly 210, the heater screw 180 and the cooling screw 182 are replaced by a pre-heating drum 280 and a cooling drum 282, respectively mounted upstream and downstream of the rotary drum/kiln 220. In the non-limitative embodiment shown, the kiln 220 is a rotary kiln but it is appreciated that it can be a non-rotary kiln such as stationary kiln or a tunnel kiln.

Thus, in the embodiment shown in FIG. 6, the kiln assembly 210 includes rotary drums 280, 282 and the heat recovery system 240 is composed of jackets surrounding the drum shell of the two rotary drums 280, 282. In the embodiment shown, the jackets are half-pipe jackets, similar to the ones described in the embodiment of FIGS. 1 and 2. However, it is appreciated that they can be conventional jackets or jackets form by a pipe/conduit surrounding at least partially the rotary drum shells. A first one of the rotary drums 280, 282, i.e a pre-heating drum 280, is placed upstream to the kiln 220 and serves the purpose of pre-heating the material before feeding it to the kiln 220. The second rotary drum 282, i.e. a cooling drum, is placed downstream to the kiln 220 and cools the hot material exiting the kiln 220. In this non-limitative embodiment shown in FIG. 6, the pre-heating drum 280, the kiln 220 and the cooling drum 282 are stacked on top of each other in a zig-zag configuration. The pre-heating drum 280 and the cooling drum 282 forms respectively the pre-heating section 234 and the cooling section 238.

In an alternative embodiment, the shells of at least one of the rotary drums 280, 282 themselves can at least partially defined by the coiled conduit 244 to form a vessel. In such embodiment, the heat transfer between the material contained in the rotary drums 280, 282 and the heat transfer fluid contained in the conduit 244 occurs solely via the conduit 244 forming the shell of the rotary drums 280, 282.

The feed material enters the pre-heating drum 280 via the feed inlet 224 and is heated therein by a heat-transfer fluid that circulates in a closed-loop heat transfer conduit circuit between the pre-heating drum 280 and the cooling drum 282. The heated feed material is transferred from an outlet 225 of the pre-heating drum 280 to a preheated feed inlet of the rotary kiln 220. The feed material is processed in the heat treatment chamber 232 of the rotary kiln 220 (i.e. heated by an external heat supply) and outputted at a hot product outlet 227. The hot product is then introduced into the cooling drum 282 via its inlet wherein it is cooled by indirect heat transfer via the heat transfer fluid. The cooled product is withdrawn via a cooled product outlet 226 of the cooling drum 282. The material processed in the kiln assembly 210 sequentially flows from the pre-heating section 234 to the hot section 236, and, then, to the cooling section 238. Thus, the pre-heating section 234 and the hot section 236 are in material communication. Similarly, the hot section 236 and the cooling section 238 are in material communication.

In that embodiment and similarly to what was described in the previous embodiments, the heat transfer conduit circuit 244 of the heat recovery system 240 is mounted to the shells (or vessels) of the rotary drums 280, 282 and the heat-transfer fluid circulates therein. The heat transfer conduit circuit 244 forms a closed-loop circulation path and has segments in contact with both vessels of the pre-heating drum 280 and the cooling drum 282. In the non-limitative embodiment shown in FIG. 6, the heat transfer conduit circuit 244 is coiled over the drum shell, outwardly thereof, in both the pre-heating drum 280 and the cooling drum 282. Therefore, the heat transfer conduit circuit 244 coiled over the shell in each one of the pre-heating drum 280 and the cooling drum 282 forms a jacket such as a half-pipe jacket (i.e., a split coil jacket) and, more particularly, a pre-heating jacket 260 and a cooling jacket 262.

The pre-heating jacket 260 and the cooling jacket 262 are in fluid communication, i.e., the heat-transfer fluid flows in both segments of the coiled pipe/conduit, through transfer segments 246, 248, which are similar to the transfer segments 46, 48, 146, 148. The transfer segment 246 of the heat transfer conduit circuit 244 connects an outlet of the pre-heating jacket 260 with an inlet of the cooling jacket 262. The transfer segment 248 connects an outlet of the cooling jacket 262 with an inlet of the pre-heating jacket 260. Thus, the transfer segments 246, 248 interconnect the pre-heating jacket 260 and the cooling jacket 262 to form a closed-loop heat transfer conduit circuit.

In the embodiment shown, in both the pre-heating drum 280 and the cooling drum 282, the heat transfer fluid flows counter-currently with the material processed in the rotary drum 220. In FIG. 6, the flow direction of the heat transfer fluid is exemplified by the arrows. In the jacket 260, the heat transfer fluid flows from an end closer to the pre-heated feed outlet 225 towards an end closer to the feed inlet 224 of the pre-heating drum 280 while the material flows from the feed inlet 224 towards the pre-heated feed outlet 225. Thus, in the pre-heating drum 280, the heat transfer fluid, having absorbed heat in the cooling drum 282, first contacts the hottest material of this section 280.

Similarly, for the cooling drum 282, the heat transfer fluid flows inside the jacket 262 from an end closer to the cooled product output 226 towards an end closer to the hot product outlet 227 of the drum 282 while the material flows from the hot product inlet 227 towards the cooled product outlet 226. In the cooling drum 282, the heat transfer fluid, having released heat to the material in the pre-heating drum 280, first contacts the coolest material of this cooling section 238. It is appreciated that, in an alternative embodiment, in one or both rotary drums 280 and 282 (or the pre-heating section 234 and the cooling section 248), the heat transfer fluid can flow co-currently with the material being conveyed.

The heat recovery system 240 also includes a fluid circulating device 250, such as a pump, to circulate the heat-transfer fluid inside the heat transfer conduit circuit at a suitable flowrate. The fluid transfer device 250 circulates the heat-transfer fluid between the cooling jacket 262 wherein the heat-transfer fluid extracts heat from the cooling drum 282 (and the material contained therein) and the pre-heating jacket 260 wherein heat contained in the heat-transfer fluid is released inside the pre-heating drum 280 and to the material contained therein.

As for the above-described embodiments, it is appreciated that at least one of the rotary kiln 220, the pre-heating drum 280 and its jacket 260, the cooling drum 282 and its jacket 262, and the transfer segments 246, 248 can be at least partially surrounded by an insulating layer 270 and, more particularly, an insulating outer layer wrapped around to reduce heat losses.

Once again, in the kiln assembly 210, the heat transfer fluid is not in direct contact with the material being processed. Heat exchanges between the material being processed occurs through a body of the pre-heating drum 280 and the cooling drum 282. Thus, the heat transfer between the material contained in the kiln assembly and, more particularly, the pre-heating drum 280 and the cooling drum 282 and the heat transfer fluid is an indirect heat exchange/transfer.

Furthermore, as for the embodiments described in reference to FIGS. 1 to 5, the heat recovery system 240 of the kiln assembly 210 recovers heat from the cooling drum 282 and the material contained therein of a kiln assembly 210 and releases the recovered heat to the pre-heating drum 280 and the material contained therein of the same kiln assembly 210.

### Example 3. Thermal Treatment of Iron Oxide Material

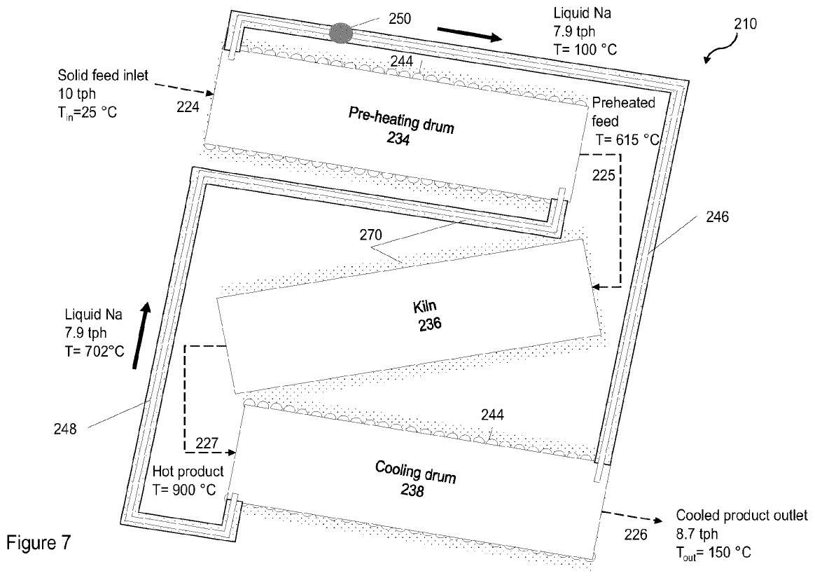

Turning now to FIG. 7, one example of a kiln including a heat recovery system, in accordance with the embodiment shown in FIG. 6 is described. The process parameters are similar to the ones of Examples 1 and 2, described above and are summarized in Table 2 above. In the example of FIG. 7, the kiln 220 is a rotary kiln.

In this embodiment, both the pre-heating drum 280 and the cooling drum 282 surrounded by a split-coil jacket 260, 262 in which a heat transfer fluid and, more particularly, is liquid sodium (Na) is flowing counter-currently versus the process material (or solid) flow. The relevant physical properties of liquid sodium are presented in the Table 1 above.

The feed material enters the pre-heating drum 280 at ambient temperature wherein it is preheated to a temperature of 615° C. by heat exchange with the liquid sodium flowing counter-currently at a flowrate of 7.9 t/h. The liquid sodium temperature at an inlet of the cooling drum 282 is 702° C. The cold liquid sodium leaving the pre-heating drum 280 at a temperature of 100° C. is pumped to the cooling drum 282 to cool the processed material exiting the rotary kiln 220.

The preheated material enters the rotary kiln 220 and is contacted by the preheated gas. Heat is provided to achieve a temperature of 900° C. in the rotary kiln 220. The heat for heating the preheated gas can be provided either directly or indirectly, by means of fired gas or electricity, for instance. In this case, the excess, and the flue gases are drawn out of the rotary kiln 220 and can be sent to another system for heat recovery.

The reacted material (Cp=1.1 kJ·kg⁻¹·K⁻¹) leaving the rotary kiln 220 at a flow rate of 8.7 metric tonnes/hour and entering the cooling drum 282 of the kiln 220 are cooled to 150° C. by the cold liquid sodium (100° C.) pumped from the cooling drum 282 and flowing counter-currently. The liquid sodium leaves the cooling drum 282 at T=702° C. and is recirculated to the cooling drum 282.

The heat requirement savings are similar to the ones described above in Examples 1 and 2, i.e. net energy savings of about 40% of the total heat requirements.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only. It will be appreciated that the methods described herein may be performed in the described order, or in any suitable order.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A kiln assembly comprising:
a kiln including a vessel having a feed inlet and a product outlet and being dividable into a pre-heating section downstream of the feed inlet, a cooling section upstream of the product outlet, and a hot section located between the pre-heating section and the cooling section; and
a heat recovery system including a heat transfer conduit circuit; a heat transfer fluid contained inside the heat transfer conduit circuit, and a fluid circulating device to circulate the heat transfer fluid inside the heat transfer conduit circuit, the heat transfer conduit circuit having a cooling segment in heat exchange communication with the vessel in the cooling section thereof for the heat transfer fluid to absorb heat from the cooling section of the vessel, a pre-heating segment in heat exchange communication with the vessel in the pre-heating section thereof for the heat transfer fluid to release heat to the pre-heating section of the vessel, a first transfer segment connecting an outlet of the pre-heating segment to an inlet of the cooling segment, and a second transfer segment connecting an outlet of the cooling segment to an inlet of the pre-heating segment.

2. The kiln assembly as claimed in claim 1, wherein each one of the cooling segment and the pre-heating segment comprises a jacket, mounted to the vessel, respectively in the cooling section and the pre-heating section.

3. (canceled)

4. The kiln assembly as claimed in claim 1, wherein the kiln is a rotary kiln and the vessel comprises a shell and each one of the cooling segment and the pre-heating segment is mounted externally to the shell of the vessel.

5. (canceled)

6. The kiln assembly as claimed in claim 1, wherein the vessel defines a heat treatment chamber and the heat transfer conduit circuit is free of segment exposed in the heat treatment chamber and the heat recovery system further comprises an insulating layer with the heat transfer conduit circuit being at least partially contained in the insulating layer, the insulating layer being located outwardly to the vessel and at least partially surround same.

7. (canceled)

8. (canceled)

9. The kiln assembly as claimed in claim 1, wherein the heat transfer fluid remains in a liquid state in at least one of: an entire operating temperature range of the kiln and from about 80° C. to about 1000° C.

10. (canceled)

11. The kiln assembly as claimed in claim 1, wherein the heat transfer fluid is selected from the group consisting of: molten metals, molten salts, and a mixture thereof; and/or from the group consisting of: alkali metals, heavy metals, eutectic mixtures, and alloys thereof.

12. (canceled)

13. A kiln assembly comprising:
a kiln having an external heat supply and a heat treatment chamber configured to contain material to be processed, the heat treatment chamber including a hot section wherein the material flowing therein is heated by the external heat supply;
a pre-heating section located upstream of the hot section and being in material communication therewith;
a cooling section located downstream of the hot section and being in material communication therewith, the material to be processed flowing sequentially in the pre-heating section, the hot section, and the cooling section; and
a heat transfer conduit circuit forming a closed loop in which circulates a heat transfer fluid, the heat transfer conduit circuit having a pre-heating segment in heat exchange with the pre-heating section and a cooling segment in heat exchange with the cooling section wherein the heat transfer fluid respectively releases heat to the material located in the pre-heating section and absorbs heat from the material located in the cooling section.

14. The kiln assembly as claimed in claim 13, wherein the kiln is a rotary kiln and comprises: a vessel having a feed inlet and a product outlet and being dividable into the pre-heating section downstream of the feed inlet, the cooling section upstream of the product outlet, and the hot section located between the pre-heating section and the cooling section.

15. The kiln assembly as claimed in claim 14, further comprising a fluid circulating device to circulate the heat transfer fluid inside the heat transfer conduit circuit, and wherein the heat transfer conduit circuit further comprises a first transfer segment connecting an outlet of the pre-heating segment to an inlet of the cooling segment and a second transfer segment connecting an outlet of the cooling segment to an inlet of the pre-heating segment.

16. (canceled)

17. (canceled)

18. (canceled)

19. The kiln assembly as claimed in claim 14, wherein the vessel comprises a shell and each one of the cooling segment and the pre-heating segment is mounted externally to the shell of the vessel.

20. The kiln assembly as claimed in claim 14, wherein each one of the cooling segment and the pre-heating segment is at least partially embedded in the vessel of the rotary kiln.

21. The kiln assembly as claimed in claim 14, wherein the heat transfer conduit circuit is free of segment exposed in the heat treatment chamber.

22. (canceled)

23. (canceled)

24. (canceled)

25. (canceled)

26. (canceled)

27. (canceled)

28. (canceled)

29. The kiln assembly as claimed in claim 13, wherein the pre-heating section comprises a pre-heating drum mounted upstream to the hot section and the pre-heating segment comprises a split-coil jacket mounted to the pre-heating drum and, wherein the cooling section comprises a cooling drum mounted downstream to the hot section and the cooling segment comprises a split-coil jacket mounted to the cooling drum.

30. (canceled)

31. (canceled)

32. (canceled)

33. (canceled)

34. (canceled)

35. The kiln assembly as claimed in claim 13, wherein the heat transfer fluid remains in a liquid state in at least one of: an entire operating temperature range of the kiln and from about 80° C. to about 1000° C.

36. (canceled)

37. The kiln assembly as claimed in claim 13, wherein the heat transfer fluid is selected from the group consisting of: molten metals, molten salts, and a mixture thereof.

38. The kiln assembly as claimed in as claimed in claim 13, wherein the heat transfer fluid is selected from the group consisting of: alkali metals, heavy metals, eutectic mixtures, and alloys thereof.

39. A heat recovery system for recycling heat during operation of a kiln assembly including a pre-heating section, a hot section, and a cooling section, the heat recovery system comprising:
a heat transfer conduit circuit having a cooling segment mounted to the cooling section of the kiln assembly to be in heat exchange communication therewith, a pre-heating segment mounted to the pre-heating section of the kiln assembly to be in heat exchange communication therewith, and a first and a second transfer segments connecting the cooling and the pre-heating segments to define a closed-loop circulation path, wherein the cooling segment comprises a jacket mounted to the cooling section of the kiln assembly, the pre-heating segment comprises a jacket mounted to the pre-heating section of the kiln assembly, and at least one of the jacket of the cooling section and the jacket of the pre-heating section is a half-pipe jacket;
a heat transfer fluid contained inside the heat transfer conduit circuit, and
a fluid circulating device to circulate the heat transfer fluid inside the heat transfer conduit circuit.

40. (canceled)

41. (canceled)

42. A method for recovering heat during operation of a kiln assembly including a pre-heating section, a hot section, and a cooling section, the method comprising:
Circulating a material sequentially in the pre-heating section, the hot section, and the cooling section of the kiln assembly;
Heating the material in the hot section of the kiln assembly;
Absorbing heat in the cooling section of the kiln assembly via a heat transfer fluid circulating in a heat transfer conduit circuit defining a closed-loop circulation path and having a cooling segment in heat exchange communication with the cooling section of the kiln assembly;
Releasing heat in the pre-heating section of the kiln assembly via the heat transfer fluid circulating in a pre-heating segment of the heat transfer conduit circuit, the pre-heating segment of the heat transfer conduit circuit being in heat exchange communication with the pre-heating section of the kiln assembly; and
Continuously circulating the heat transfer fluid in the closed-loop circulation path between the cooling and the pre-heating segments of the heat transfer conduit circuit during operation of the kiln assembly to continuously absorb heat in the cooling section of the kiln assembly and release the absorbed heat in the pre-heating section of the kiln assembly while maintaining the heat transfer fluid in a liquid state in an entire operating temperature range of the kiln assembly.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. The method as claimed in claim 42, wherein the heat transfer fluid is selected from the group consisting of: molten metals, molten salts, and a mixture thereof.

56. The method as claimed in claim 42, wherein the heat transfer fluid is selected from the group consisting of: alkali metals, heavy metals, eutectic mixtures, and alloys thereof.
